(19) United States
(12) Patent Application Publication
(10) Pub. No.: US 2024/0096755 A1
(43) Pub. Date: Mar. 21, 2024

(54) INTEGRATED CIRCUIT DEVICES

(71) Applicant: SAMSUNG ELECTRONICS CO., LTD., Suwon-si (KR)

(72) Inventors: Heewon KANG, Suwon-si (KR); Byungsu KIM, Suwon-si (KR); Sunhee PARK, Suwon-si (KR); Sangjoon CHEON, Suwon-si (KR); Jaeseung CHOI, Suwon-si (KR)

(21) Appl. No.: 18/462,883

(22) Filed: Sep. 7, 2023

(30) Foreign Application Priority Data
Sep. 21, 2022 (KR) 10-2022-0119540

(51) Int. Cl. H01L 23/48; G06F 30/392; G06F 30/394

(52) U.S. Cl. CPC H01L 23/481; G06F 30/392; G06F 30/394; G06F 2119/06

(57) ABSTRACT

An integrated circuit device includes a first chip and a second chip. The first chip includes a first substrate including a through-via region, a prohibition region, and a device region, the prohibition region surrounding the through-via region in a plan view. The first chip further includes a through-via penetrating the first substrate in the through-via region, and a power gating cell disposed in the prohibition region. The second chip includes a second substrate, and a plurality of circuit blocks configured to receive power and/or signals through the through-via.

### CROSS-REFERENCE TO RELATED APPLICATION

This application is based on and claims priority under 35 U.S.C. § 119 to Korean Patent Application No. 10-2022-0119540, filed on Sep. 21, 2022, in the Korean Intellectual Property Office, the disclosure of which is incorporated by reference herein in its entirety.

### BACKGROUND

The inventive concept relates to integrated circuit devices, and more particularly, to three-dimensional integrated circuit devices each including a plurality of stacked semiconductor dies.

Electronic products are required to be small and have multiple functions and high performance, and thus, high-capacity integrated circuit devices are required. Three-dimensional integrated circuit devices each including a plurality of semiconductor dies electrically connected to each other using through-vias have been proposed as high-capacity integrated circuit devices.

### SUMMARY

The inventive concept provides three-dimensional integrated circuit devices improved in the degree of integration and the efficiency of space utilization.

According to an aspect of the inventive concept, there is provided an integrated circuit device including a first chip and a second chip on the first chip. The first chip includes a first substrate, a through-via, and a power gating cell. The first substrate includes a through-via region, a prohibition region, and a device region, and the prohibition region surrounds the through-via region in a plan view. The through-via is in the through-via region and the first substrate. The power gating cell is disposed in the prohibition region. The second chip includes a second substrate, and a second logic block on the second substrate. The second logic block is configured to receive power and/or signals through the through-via.

According to another aspect of the inventive concept, there is provided an integrated circuit device including a first semiconductor die and a second semiconductor die. The first semiconductor die includes a plurality of first logic blocks and a through-via. The second semiconductor die is disposed on the first semiconductor die and includes a second logic block. The first semiconductor die further includes a first substrate and a power gating cell. The first substrate includes a through-via region, a prohibition region, and a device region, and has a first surface of the first substrate and a second surface of the first substrate that is opposite to the first surface of the first substrate. The through-via is in the through-via region and in the first substrate. The power gating cell is disposed in the prohibition region on the first surface of the first substrate. The plurality of first logic blocks is disposed in the device region on the first surface of the first substrate. The second semiconductor die further includes a second substrate. The second substrate includes a first surface of the second substrate facing the second surface of the first substrate and a second surface of the second substrate opposite to the first surface of the second substrate. The second logic block is disposed on the first surface of the second substrate and is electrically connected to the first semiconductor die through the through-via. A first distance to the through-via region from a nearest first logic block among the plurality of first logic blocks disposed closest to the through-via region is longer than a second distance to the through-via from the power gating cell.

According to another aspect of the inventive concept, there is provided an integrated circuit device including a first semiconductor die, and a second semiconductor die disposed on the first semiconductor die. The first semiconductor die includes a first substrate, a through-via, and a power gating cell, and a first logic block. The first substrate includes a through-via region, a prohibition region, and a device region. The prohibition region surrounds the through-via region in a plan view. The first substrate has a first surface of the first substrate and a second surface of the first substrate opposite to the first surface of the first substrate. The through-via is in the through-via region and in the first substrate. The power gating cell is disposed in the prohibition region on the first surface of the first substrate. The first logic block is disposed in the device region on the first surface of the first substrate. The second semiconductor die includes a second substrate and a second logic block. The second substrate has a first surface of the second substrate facing the second surface of the first substrate and a second surface of the second substrate opposite the first surface of the second substrate. The second logic block is disposed on the first surface of the second substrate and is configured to receive power and/or signals through the through-via.

### BRIEF DESCRIPTION OF THE DRAWINGS

Embodiments of the inventive concept will be more clearly understood from the following detailed description taken in conjunction with the accompanying drawings in which:

FIG. 1 is a perspective view illustrating an integrated circuit device according to some embodiments;

FIG. 2 is a plan view illustrating a portion of the integrated circuit device in FIG. 1 according to some embodiments;

FIG. 3 is an enlarged view illustrating a portion A of FIG. 2;

FIG. 4 is a cross-sectional view taken along line B-B′ of FIG. 3;

FIG. 5 is a block diagram illustrating a power gating circuit according to some embodiments;

FIGS. 6 to 8 are cross-sectional views illustrating a plurality of first logic blocks and a power gating cell according to some embodiments;

FIG. 9 is a cross-sectional view illustrating an integrated circuit device according to some embodiments;

FIG. 10 is a cross-sectional view illustrating an integrated circuit device according to some embodiments;

FIG. 11 is a plan view illustrating an integrated circuit device according to some embodiments;

FIG. 12 is an enlarged view illustrating a portion A of FIG. 11;

FIG. 13 is a plan view illustrating an integrated circuit device according to some embodiments;

FIG. 14 is a flowchart illustrating a method of fabricating an integrated circuit including a plurality of standard cells, according to some embodiments;

FIG. 15 is a block diagram illustrating a system-on-chip (SoC) according to some embodiments; and

FIG. 16 is a block diagram illustrating a computing system including a memory storing a program according to some embodiments.

### DETAILED DESCRIPTION OF THE EMBODIMENTS

Hereinafter, embodiments of the inventive concept will be described with reference to the accompanying drawings.

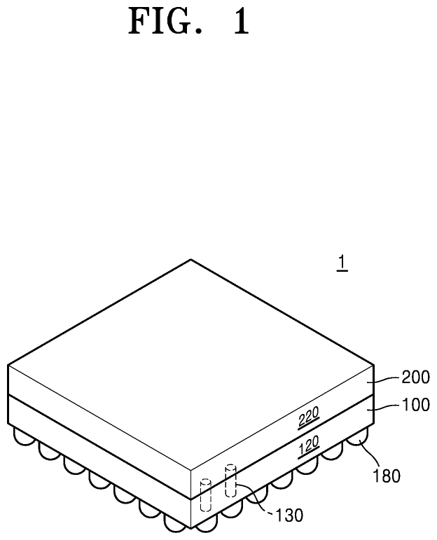

FIG. 1 is a perspective view illustrating an integrated circuit device 1 according to some embodiments.

Referring to FIG. 1, the integrated circuit device 1 may be a three-dimensional integrated circuit device having a structure in which a second semiconductor die 200, which may be referred to as a second chip 200, is disposed on a first semiconductor die 100, which may be referred to as a first chip 100. The first semiconductor die 100 may include a plurality of first logic blocks 120, and the second semiconductor die 200 may include a plurality of second logic blocks 220.

An external connection terminal 180 may be disposed on a lower surface of the first semiconductor die 100, and power and/or signals may be provided to the plurality of first logic blocks 120 of the first semiconductor die 100 through the external connection terminal 180. The first semiconductor die 100 may include a through-via 130, and power and/or signals may be provided to the plurality of second logic blocks 220 of the second semiconductor die 200 from the external connection terminal 180 through the through-via 130.

In some embodiments, each of the plurality of first logic blocks 120 and the plurality of second logic blocks 220 may include, for example, an inverter, a NAND gate, an AND gate, a NOR gate, an OR gate, an XOR gate, an XNOR gate, a multiplexer, an adder, a latch, a flip-flop, and/or the like.

In some embodiments, each of the first semiconductor die 100 and the second semiconductor die 200 may include complex functional blocks such as intellectual property (IP) blocks configured to perform various functions. For example, the first semiconductor die 100 and the second semiconductor die 200 may include various functional blocks such as a modem, a display controller, a memory, an external memory controller, a central processing unit (CPU), a transaction unit, a power management integrated circuit (PMIC), and/or a graphics processing unit (GPU), but not limited thereto. In addition, the functional blocks of the first semiconductor die 100 and the second semiconductor die 200 may communicate with each other through a system bus.

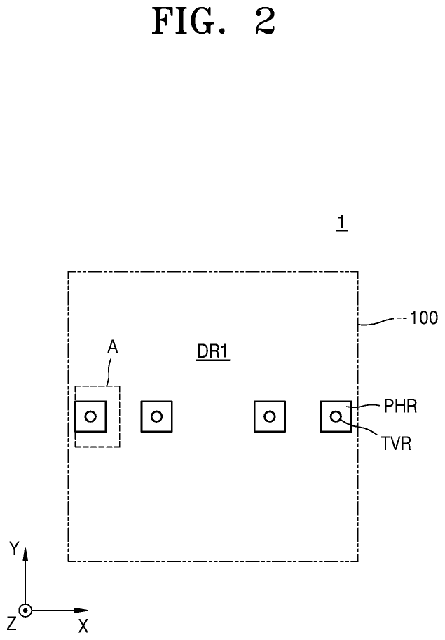

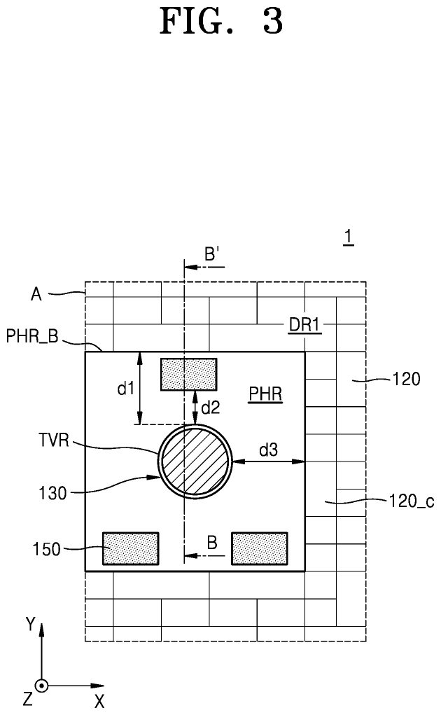

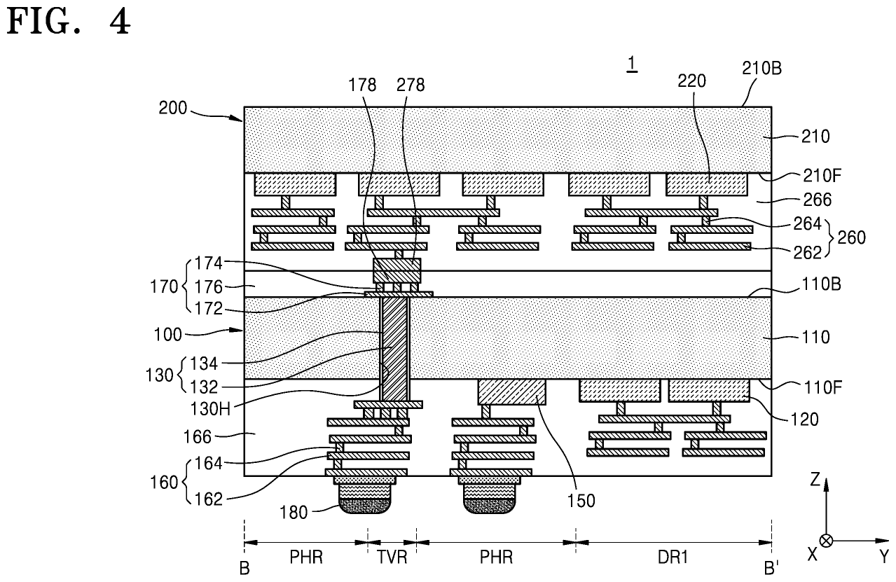

FIG. 2 is a plan view illustrating a portion of the integrated circuit device 1 in FIG. 1 according to some embodiments. FIG. 3 is an enlarged view illustrating a portion A of FIG. 2, and FIG. 4 is a cross-sectional view taken along line B-B′ of FIG. 3.

Referring to FIGS. 2 to 4, the first semiconductor die 100 may include a first substrate 110, which includes a through-via region TVR, a prohibition region PHR, and a first device region DR1.

The through-via region TVR may be a region in which a through-via 130 penetrates the first substrate 110 and extends in a vertical direction Z. The vertical direction Z may be perpendicular to an upper surface (e.g., first surface 110F) of the first substrate 110. As shown in FIG. 2, a plurality of through-via regions TVR may be formed apart from each other, and one through-via 130 may be formed in each of the through-via regions TVR. The number of through-via 130 in each of the through-via regions TVR, however, may not be limited thereto.

The prohibition region PHR may be on at least one side of the through-via region TVR. For example, in a plan view shown in FIG. 2, the prohibition region PHR may surround the through-via region TVR. For example, the prohibition region PHR may be provided around the through-via region TVR in a manner such that the prohibition region PHR may have a boundary PHR_B at a first distance d1 from the through-via region TVR (e.g., from the through-via 130) in a first horizontal direction X and a second horizontal direction Y. The first horizontal direction X may be parallel to the upper surface (e.g., first surface 110F) of the first substrate 110. The second horizontal direction Y may be parallel to the upper surface (e.g., first surface 110F) of the first substrate 110. The first horizontal direction X may intersect with the second horizontal direction Y. Here, the boundary PHR_B of the prohibition region PHR may refer to a boundary (interface) between the prohibition region PHR and the first device region DR1. In some embodiments, the first distance d1 may range from about 1 micrometer to about 10 micrometers, but is not limited thereto.

The first device region DR1 may be provided on at least one side of the prohibition region PHR, and the prohibition region PHR may be provided between the first device region DR1 and the through-via region TVR. The first device region DR1 may be a region in which the plurality of first logic blocks 120 are arranged. For example, the plurality of first logic blocks 120 may include various logic circuits such as an inverter, a NAND gate, an AND gate, a NOR gate, an OR gate, an XOR gate, an XNOR gate, a multiplexer, an adder, a latch, a flip-flop, and/or the like.

The prohibition region PHR may be a buffer region for securing a physical distance between the through-via 130 and the plurality of first logic blocks 120 arranged in the first device region DR1. For example, the prohibition region PHR in which the plurality of first logic blocks 120 are not arranged may be provided around the through-via 130 to prevent a decrease in the electrical performance of the plurality of first logic blocks 120, which may be caused by thermal stress applied to the plurality of first logic blocks 120 during a process of forming the through-via 130.

FIGS. 2 and 3 illustrate an example in which the prohibition region PHR has a square or rectangular horizontal cross-sectional shape. In other embodiments, however, the prohibition region PHR may have, but not limited thereto, an elliptical, circular, or rounded quadrangular horizontal cross-sectional shape.

As shown in FIG. 3, at least one power gating cell 150 may be disposed in the prohibition region PHR. The power gating cell 150 may be disposed on a first surface 110F of the first substrate 110 and may be configured to apply power to the plurality of first logic blocks 120 arranged in the first device region DR1. In some embodiments, the power gating cell 150 may include a p-channel metal-oxide-semiconductor (PMOS) transistor, but not limited thereto. The power gating cell 150 may be configured to convert a power source voltage provided from the external connection terminal 180 into a virtual voltage and provide the virtual voltage to the plurality of first logic blocks 120. Although not shown in the accompanying drawings, in some embodiments, at least one power gating cell 150 may be disposed in the prohibition region PHR, and at least one other power gating cell 150 may be disposed in the first device region DR1.

The power gating cell 150 may be disposed in the prohibition region PHR and may be at a second distance d2 from the through-via region TVR (e.g., from the through-via 130). The second distance d2 may range from about 0.5 micrometer to about 10 micrometers. In some embodiments, a nearest first logic block 120_c among the plurality of first logic blocks 120 disposed closest to the through-via region TVR may be at a third distance d3 from the through-via region TVR (e.g., from the through-via 130), and the second distance d2 between the power gating cell 150 and the through-via region TVR may be shorter than the third distance d3. In some embodiments, the third distance d3 between the through-via region TVR and the nearest first logic block 120_c disposed closest to the through-via region TVR may be within a range of about 1 micrometer to about 10 micrometers. However, embodiments are not limited thereto.

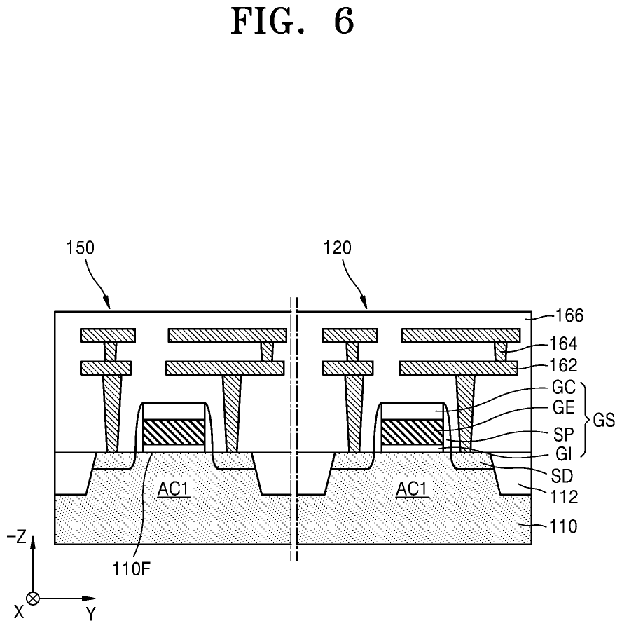

For example, as shown in FIGS. 3 and 4, the power gating cell 150 may be apart from the boundary PHR_B of the prohibition region PHR, and an electrical isolation region such as a device isolation layer 112 (shown in FIG. 6) having a relatively large width may be disposed between the boundary PHR_B of the prohibition region PHR and the power gating cell 150. For example, the electrical isolation region may include a deep trench isolation (DTI) region or a shallow trench isolation (STI) region. In other embodiments, the power gating cell 150 may be disposed adjacent to the boundary PHR_B of the prohibition region PHR, and an electrical isolation region such as the device isolation layer 112 having a relatively small width may be disposed between the boundary PHR_B of the prohibition region PHR and the power gating cell 150.

In some embodiments, the power gating cell 150 may have relatively greater resistance to thermal stress and/or mechanical stress occurring during a process of forming the through-via 130 than the plurality of first logic blocks 120. For example, circuits included in the plurality of first logic blocks 120 may include PMOS transistors and n-type metal-oxide-semiconductor (NMOS) transistors, and because the NMOS transistors may operate more sensitively to thermal stress and/or mechanical stress occurring during the process of forming the through-via 130 than the PMOS transistors, the NMOS transistors may be separated from the through-via 130 by a sufficient distance. In some embodiments, however, the power gating cell 150 may include only a PMOS transistor, and thus the power gating cell 150 may operate less sensitively to thermal stress and/or mechanical stress occurring during the process of forming the through-via 130. However, the technical idea of the inventive concept is not limited thereto, and in other embodiments, the power gating cell 150 may include only an NMOS transistor. In other embodiments, the power gating cell 150 may include both PMOS and NMOS transistors.

Because at least one power gating cell 150 is disposed in the prohibition region PHR, the degree of integration of the integrated circuit device 1 may improve, and even when the density of through-vias 130 increases, area overhead caused by an increase in the area of prohibition regions PHR along the density increase of the through-vias 130 may reduce, thereby improving the efficiency of space utilization of the integrated circuit device 1.

As shown in FIG. 4, the first substrate 110 may include the first surface 110F and a second surface 110B opposite to the first surface 110F, and circuits of the plurality of first logic blocks 120 may be arranged on the first surface 110F of the first substrate 110. In addition, the power gating cell 150 may be disposed on the first surface 110F of the first substrate 110.

The through-via 130 may penetrate the first substrate 110 from the first surface 110F of the first substrate 110 to the second surface 110B of the first substrate 110 in the vertical direction Z. Here, the expression “the through-via 130 penetrates the first substrate 110” may mean that an end of the through-via 130 is exposed at the first surface 110F of the first substrate 110, and the other end of the through-via 130 is exposed at the second surface 110B of the first substrate 110. For example, the through-via 130 may have a height equal to or greater than the height of the first substrate 110 in the vertical direction Z.

In some embodiments, the through-via 130 may be disposed in a via hole 130H penetrating the first substrate 110 in the vertical direction Z. The through-via 130 may include: a through-via conductive layer 132 filling the via hole 130H; and a through-via insulating layer 134 on (e.g., surrounding) a sidewall of the through-via conductive layer 132 and disposed between the through-via conductive layer 132 and the first substrate 110

A first connection structure 160 electrically connected to (the circuits of) the plurality of first logic blocks 120 and the power gating cell 150 may be disposed on the first surface 110F of the first substrate 110. The first connection structure 160 may include: a plurality of first wiring layers 162; and a plurality of first conductive vias 164 connecting together the plurality of first wiring layers 162 disposed at different vertical levels. A first interlayer insulating film 166 may be disposed on the first surface 110F of the first substrate 110. The first interlayer insulating film 166 may be disposed on (cover) the plurality of first wiring layers 162 and the plurality of first conductive vias 164. The first interlayer insulating film 166 may include a plurality of insulating layers.

The external connection terminal 180 may be disposed on the first interlayer insulating film 166 disposed on the first surface 110F of the first substrate 110. The external connection terminal 180 may include, for example, a solder bump, a solder ball, and/or the like.

A rear surface structure 170 may be disposed on the second surface 110B of the first substrate 110. The rear surface structure 170 may include a rear surface wiring layer 172, a rear surface via 174, and a rear surface insulating layer 176. The rear surface wiring layer 172 and the rear surface via 174 may be electrically connected to the through-via 130 and may function as an electrical connection portion for connecting the first semiconductor die 100 and the second semiconductor die 200 to each other.

The second semiconductor die 200 may include: a second substrate 210 including a first surface 210F and a second surface 210B; and the plurality of second logic blocks 220 arranged on the first surface 210F of the second substrate 210. A second connection structure 260 electrically connected to the plurality of second logic blocks 220 may be disposed on the first surface 210F of the second substrate 210, and a second interlayer insulating film 266 may be disposed on the first surface 210F of the second substrate 210. The plurality of second logic blocks 220 may be electrically connected to the first semiconductor die 100 through the through-via 130. The second interlayer insulating film 266 may cover the plurality of second logic blocks 220 and the second connection structure 260. For example, the second connection structure 260 may include: a plurality of second wiring layers 262; and a plurality of second conductive vias 264 connecting together the plurality of second wiring layers 262 disposed at different vertical levels. In some embodiments, the second substrate 210 may be disposed on the first substrate 110 such that the first surface 210F of the second substrate 210 may face the second surface 110B of the first substrate 110.

In some embodiments, the second semiconductor die 200 may be bonded to the first semiconductor die 100 by a metal-oxide hybrid bonding method. For example, as shown in FIG. 4, a second bonding pad 278 including copper or a copper alloy, but not limited thereto, may be disposed on the first surface 210F of the second substrate 210 such that an upper surface of the second bonding pad 278 may be at the same level as the second interlayer insulating film 266 (here, the upper surface of the second bonding pad 278 may refer to a surface of the second bonding pad 278 facing the first substrate 110). In addition, a first bonding pad 178 including copper or a copper alloy, but not limited thereto, may be disposed on the second surface 110B of the first substrate 110 such that an upper surface of the first bonding pad 178 may be at the same level as the rear surface insulating layer 176 (here, the upper surface of the first bonding pad 178 may refer to a surface of the first bonding pad 178 facing the second substrate 210). The second semiconductor die 200 may be attached to the first semiconductor die 100 by bonding the rear surface insulating layer 176 and the second interlayer insulating film 266 to each other, and bonding the first bonding pad 178 and the second bonding pad 278 to each other.

In other embodiments, the second semiconductor die 200 may be attached to the first semiconductor die 100 using a connection member such as a micro-bump or a solder bump. In this case, an underfill member surrounding the connection member such as a micro-bump or a solder bump may be optionally disposed between the second semiconductor die 200 and the first semiconductor die 100.

In some embodiments, the plurality of second logic blocks 220 may include various logic circuits such as an inverter, a NAND gate, an AND gate, a NOR gate, an OR gate, an XOR gate, an XNOR gate, a multiplexer, an adder, a latch, a flip-flop, and/or the like. In other embodiments, in addition to the plurality of second logic blocks 220, various functional blocks such as a modem, a display controller, a memory, an external memory controller, a CPU, a transaction unit, a PMIC, and/or a GPU, but not limited thereto, may be arranged on the second substrate 210.

The plurality of second logic blocks 220 may be configured to receive power or signals from the external connection terminal 180 disposed on the lower surface of the first semiconductor die 100. For example, the external connection terminal 180 arranged on the lower surface of the first semiconductor die 100 may provide power or signals to the plurality of second logic blocks 220 through the through-via 130, the first and second bonding pads 178 and 278, and the second connection structure 260.

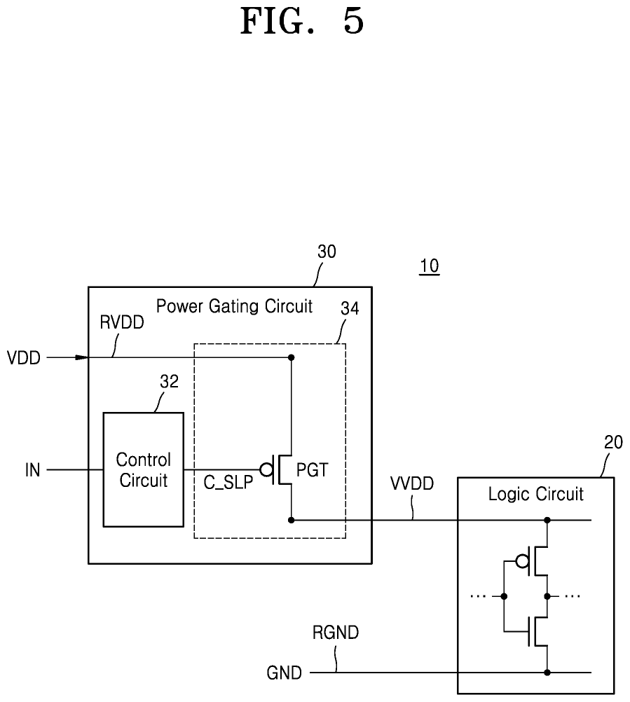

FIG. 5 is a block diagram illustrating a power gating circuit according to some embodiments.

Referring to FIG. 5, an integrated circuit device 10 may include a logic circuit 20 and a power gating circuit 30 configured to provide power to the logic circuit 20. The logic circuit 20 may correspond to the plurality of first logic blocks 120 included in the first semiconductor die 100 shown in FIGS. 1 to 4 and/or the plurality of second logic blocks 220 included in the second semiconductor die 200 shown in FIGS. 1 to 4. The power gating circuit 30 may correspond to the power gating cell 150 included in the first semiconductor die 100 shown in FIGS. 1 to 4.

The logic circuit 20 may be connected to a first virtual power line VVDD and a second power line RGND and may receive power through the first virtual power line VVDD and the second power line RGND. In an embodiment, the second power line RGND may be a ground line, and ground voltage GND may be applied to the logic circuit 20 through the second power line RGND.

The power gating circuit 30 may be connected to a first power line RVDD, which provides power voltage VDD to the power gating circuit 30. The power gating circuit 30 may adjust a first driving voltage provided to the logic circuit 20 and a power mode of the logic circuit 20 by selectively connecting the first power line RVDD to the first virtual power line VVDD in response to a control signal IN.

For example, the power gating circuit 30 may provide the power voltage VDD to the logic circuit 20 by connecting the first power line RVDD to the first virtual power line VVDD in a power-on mode, and the power gating circuit 30 may float the first virtual power line VVDD by disconnecting the first power line RVDD and the first virtual power line VVDD from each other in a power-off mode.

The integrated circuit device 10 may further include a power management circuit, and the control signal IN may be provided from the power management circuit provided outside the power gating circuit 30. The power management circuit of the integrated circuit device 10 may apply the control signal IN to the power gating circuit 30 such that the level of voltage provided to the logic circuit 20 may vary according to power modes.

The logic circuit 20 may selectively receive power through the first virtual power line VVDD. The logic circuit 20 may receive a first driving voltage varying according to power modes. For example, the logic circuit 20 may receive the power voltage VDD in the power-on mode and may not receive power in the power-off mode. Although FIG. 5 illustrates that the integrated circuit device 10 is driven in the power-on mode and the power-off mode, the integrated circuit device 10 may be further configured to be driven in one or more retention modes in addition to the power-on mode and the power-off mode.

The logic circuit 20 may include any circuit connected to the first virtual power line VVDD. For example, the logic circuit 20 may include an inverter, a NAND gate, an AND gate, a NOR gate, an OR gate, an XOR gate, an XNOR gate, a multiplexer, an adder, a latch, a flip-flop, and/or the like.

The power gating circuit 30 may include, for example: a sleep control transistor unit 34 connected between the first power line RVDD and the first virtual power line VVDD; and a control circuit 32 configured to provide switching signals C_SLP to the sleep control transistor unit 34. In other embodiments, unlike that shown in FIG. 5, the power gating circuit 30 may not include the control circuit 32, and the sleep control transistor unit 34 may directly receive the switching signals C_SLP from the outside circuit of the power gating circuit 30. In some embodiments, the sleep control transistor unit 34 may include a sleep control transistor PGT implemented with a PMOS transistor, but not limited thereto.

For example, in the power-on mode, the control circuit 32 may generate the switching signal C_SLP at a logic low level for turning on the sleep control transistor unit 34, and the first virtual power line VVDD may be connected to the logic circuit 20 by the sleep control transistor unit 34 according to the switching signal C_SLP. In the power-off mode, the control circuit 32 may generate the switching signal C_SLP at a logic high level for turning off the sleep control transistor unit 34. Then, the sleep control transistor unit 34 may be turned off by the switching signal C_SLP, and the first virtual power line VVDD may be disconnected from the first power line RVDD and floated.

The power gating circuit 30 is described with reference to FIG. 5 according to some embodiments, and it should be understood that various types of power gating circuits may be used as the power gating cell 150. In other embodiments, the power gating circuit 30 may include a first sleep control transistor implemented with a PMOS transistor, a second sleep control transistor implemented with an NMOS transistors, and an inverter electrically connected to the second sleep control transistor, but not limited thereto.

FIGS. 6 to 8 are cross-sectional views illustrating a plurality of first logic blocks 120 and a power gating cell 150 according to some embodiments.

Referring to FIG. 6, the plurality of first logic blocks 120 and the power gating cell 150 may be implemented with planar field effect transistors (FETs).

In some embodiments, a plurality of active regions AC1 may be defined by a device isolation layer 112 provided on a first surface 110F of a first substrate 110. Each of the plurality of first logic blocks 120 and the power gating cell 150 may include: a gate structure GS provided on the first surface 110F of the first substrate 110; and source/drain regions SD provided in the first substrate 110 at both sides of the gate structure GS. For example, the gate structure GS may include a gate insulating layer GI, a gate electrode GE, and a gate capping layer GC, which are sequentially disposed on the first surface 110F of the first substrate 110. In addition, the gate structure GS may include a gate spacer SP provide on at least a portion of sidewalls of the gate insulating layer GI, the gate electrode GE, and the gate capping layer GC.

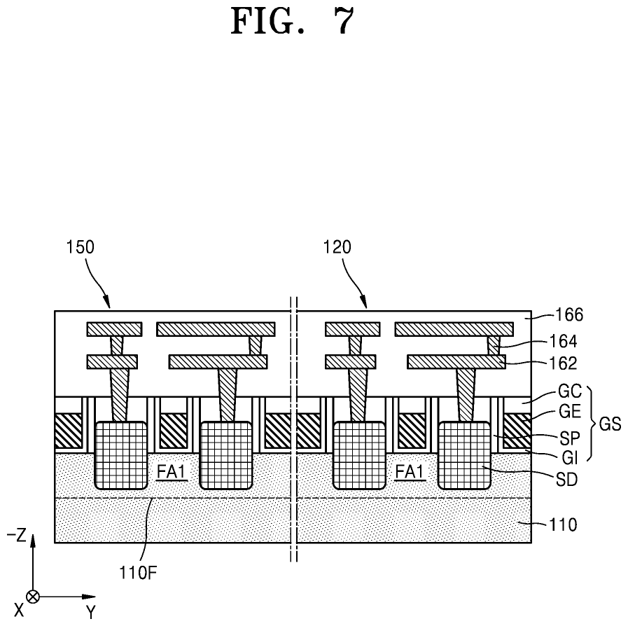

Referring to FIG. 7, the plurality of first logic blocks 120 and the power gating cell 150 may be implemented with fin FETs (finFETs).

In some embodiments, a plurality of fin-type active regions FA1 protruding in a vertical direction −Z (opposite to the vertical direction Z) may be defined on the first surface 110F of the first substrate 110. The plurality of first logic blocks 120 and the power gating cells 150 may include: gate structures GS extending in the first horizontal direction X to cross the plurality of fin-type active regions FA1 on the first surface 110F of the first substrate 110; and source/drain regions SD provided in the plurality of fin-type active regions FA1 at both sides of the gate structures GS. For example, the gate structures GS may include gate electrodes GE disposed on the plurality of fin-type active regions FA1, gate insulating layers GI on (e.g., covering) sidewalls and bottom surfaces of the gate electrodes GE; and gate capping layers GC provided on upper surfaces of the gate electrodes GE. In addition, the gate structures GS may include gate spacers SP provided on at least a portion of sidewalls of the gate insulating layers GI, the gate electrodes GE, and the gate capping layers GC.

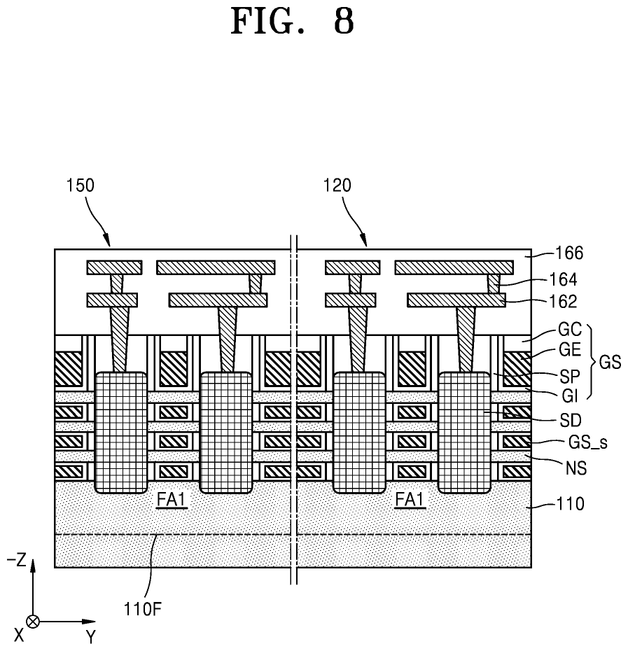

Referring to FIG. 8, the plurality of first logic blocks 120 and the power gating cells 150 may be implemented with multi-bridge channel FETs.

In some embodiments, a plurality of fin-type active regions FA1 protruding in the vertical direction −Z may be defined on the first surface 110F of the first substrate 110, and a plurality of semiconductor patterns NS arranged apart from each other in the vertical direction −Z may be provided on (above) the plurality of fin-type active regions FA1. The plurality of semiconductor patterns NS may include a nanosheet of a semiconductor material such as silicon, silicon-germanium, gallium arsenide, and/or indium phosphide, but not limited thereto. For example, each of the plurality of semiconductor patterns NS may have a width of about 1 nanometer to about 50 nanometers in a second horizontal direction Y, a width of about 1 nanometer to about 50 nanometers in the first horizontal direction X, and a thickness of about 1 nanometer to about 20 nanometers in the vertical direction −Z. However, embodiments are not limited thereto. The plurality of semiconductor patterns NS may function as channel regions of the plurality of first logic blocks 120 and the power gating cell 150.

The plurality of first logic blocks 120 and the power gating cell 150 may include: gate structures GS extending in the first horizontal direction X on (surrounding) the plurality of semiconductor patterns NS provided on (above) the plurality of fin-type active regions FA1; and source/drain regions SD connected to ends of the plurality of semiconductor patterns NS at sides of the gate structures GS. For example, each of the gate structures GS may include: gate insulating layers GI on (surrounding) surfaces of the plurality of semiconductor patterns NS; gate electrodes GE provided on the gate insulating layers GI and filling spaces between the plurality of semiconductor patterns NS; gate capping layers GC provided on upper surfaces of the gate electrodes GE; and gate spacers SP provided on sides of the gate electrodes GE. Each of sub-gate structures GS_s of the gate structures GS may be disposed in a space between two semiconductor patterns NS that are adjacent to each other in the vertical direction −Z.

FIGS. 6 to 8 illustrate example transistor structures that may be employed as the plurality of first logic blocks 120 and the power gating cell 150. However, the plurality of first logic blocks 120 and the power gating cell 150 may include various types of integrated circuit elements having various structures other than those described with reference to FIGS. 6 to 8. For example, the plurality of first logic blocks 120 and the power gating cell 150 may have various structures such as a vertical channel transistor structure, a negative capacitance FET structure, or a ferroelectric FET structure, but not limited thereto.

The descriptions of the plurality of first logic blocks 120 and the power gating cell 150 given with reference to FIGS. 6 to 8 may be applied to circuits of the plurality of second logic blocks 220 included in the second semiconductor die 200. For example, the plurality of second logic blocks 220 may have the transistor structures described with reference to FIGS. 6 to 8, and may additionally have a structure such as a vertical channel transistor structure, a negative capacitance FET structure, or a ferroelectric FET structure, but not limited thereto.

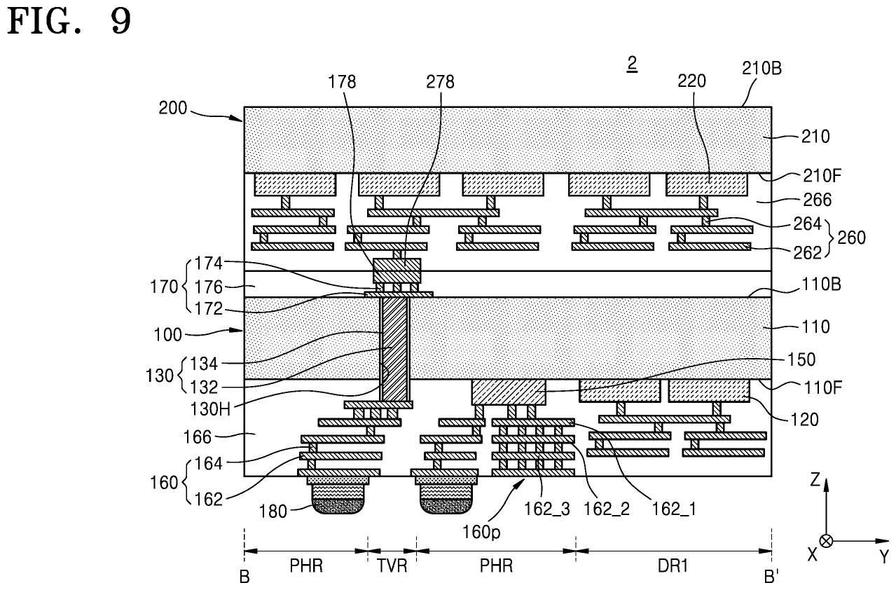

FIG. 9 is a cross-sectional view illustrating an integrated circuit device 2 according to some embodiments. In FIG. 9, the same reference numerals as in FIGS. 1 to 8 denote the same elements.

Referring to FIG. 9, a first semiconductor die 100 may further include a first power interconnection structure 160p disposed on a first surface 110F of a first substrate 110. The first power interconnection structure 160p may include: a plurality of first wiring layers 162 provided at the same vertical level and different vertical levels; and a plurality of first conductive vias 164 connected between the plurality of first wiring layers 162 disposed at different vertical levels. For example, the plurality of first wiring layers 162 may include: a first sub wiring layer 162_1 disposed at a first vertical level; a second sub wiring layer 162_2 disposed at a second vertical level higher than the first vertical level (for example, the second sub wiring layer 162_2 is farther from the first surface 110F of the first substrate 110 than the first sub wiring layer 162_1); and a third sub wiring layer 162_3 disposed at a third vertical level that is higher than the second vertical level (for example, the third sub wiring layer 162_3 is farther from the first surface 110F of the first substrate 110 than the second sub wiring layer 162_2).

FIG. 9 illustrates an example in which the first sub wiring layer 162_1 disposed at the first vertical level extends in the same direction (for example, a second horizontal direction Y) as the second sub wiring layer 162_2 disposed at the second vertical level that is higher than the first vertical level. However, the technical idea of the inventive concept is not limited thereto.

In other embodiments, the first sub wiring layer 162_1 disposed at the first vertical level may extend in a first horizontal direction X, the second sub wiring layer 162_2 disposed at the second vertical level that is higher than the first vertical level may extend in the second horizontal direction Y, and the third sub wiring layer 162_3 disposed at the third vertical level that is higher than the second vertical level may extend in the first horizontal direction X. That is, each first wiring layers 162 disposed at one vertical level may have a unidirectional wiring structure. However, the technical idea of the inventive concept is not limited thereto.

When power is supplied from an external connection terminal 180 to a power gating cell 150, the power may be transmitted to a plurality of first logic blocks 120 through the first power interconnection structure 160p. The power gating cell 150 may be electrically connected to the first power interconnection structure 160p. The power (and/or signals) may be transmitted to the through-via 130 through the first power interconnection structure 160p. The first power interconnection structure 160p may have reduced wiring resistance, and thus, an operating voltage may be stably provided to the plurality of first logic blocks 120 through the first power interconnection structure 160p.

In some embodiments, the power gating cell 150 and the first power interconnection structure 160p may be arranged in a prohibition region PHR, thereby reducing area overhead and increasing the efficiency of space utilization compared to the case in which the power gating cell 150 and the first power interconnection structure 160p are arranged in a first device region DR1.

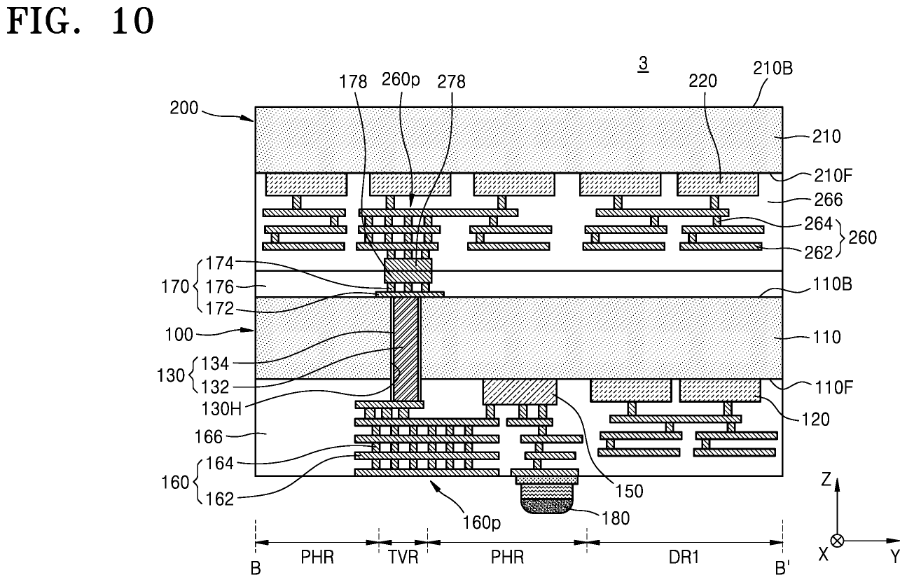

FIG. 10 is a cross-sectional view illustrating an integrated circuit device 3 according to some embodiments. In FIG. 10, the same reference numerals as in FIGS. 1 to 9 denote the same elements.

Referring to FIG. 10, a second power interconnection structure 260p may be further disposed in a region of a second semiconductor die 200 that overlaps a prohibition region PHR and a through-via region TVR. For example, the second power interconnection structure 260p may include: a plurality of second wiring layers 262 disposed at the same vertical level and different vertical levels; and a plurality of second conductive vias 264 connected between a plurality of second wiring layers 262 disposed at different vertical levels.

In some embodiments, power may be supplied from an external connection terminal 180 commonly to a plurality of first logic blocks 120 of a first semiconductor die 100 and a plurality of second logic blocks 220 of the second semiconductor die 200. For example, power may be provided to a power gating cell 150 from the external connection terminal 180, and the power may be transmitted from the power gating cell 150 to a through-via 130 through a first power interconnection structure 160p. In addition, the power may be transmitted from the through-via 130 to the plurality of second logic blocks 220 through the second power interconnection structure 260p in the second semiconductor die 200. In addition, the power gating cell 150 may provide the power to the plurality of first logic blocks 120.

The first power interconnection structure 160p and the second power interconnection structure 260p may have reduced wiring resistance, and thus an operating voltage may be stably provided to the plurality of second logic blocks 220 through the first power interconnection structure 160p and the second power interconnection structure 260p.

According to the embodiments, the second power interconnection structure 260p may be disposed in a region overlapping the through-via region TVR and the prohibition region PHR, thereby reducing area overhead and improving the efficiency of space utilization.

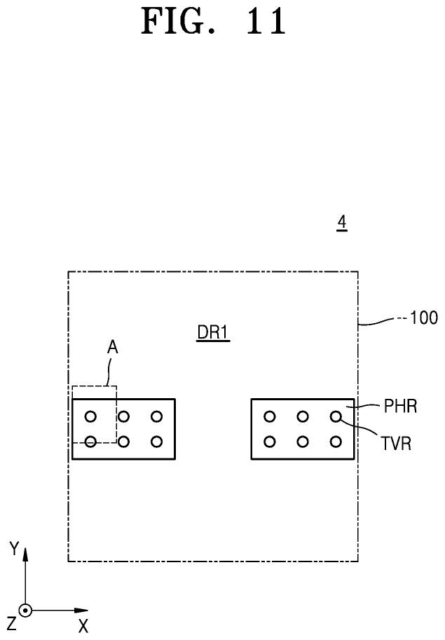

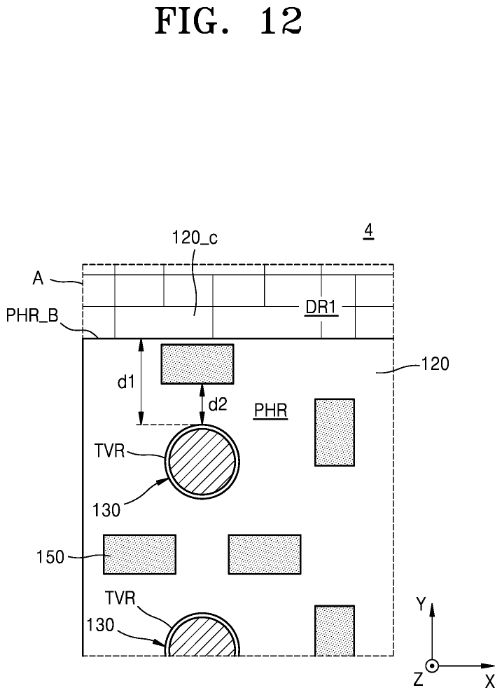

FIG. 11 is a plan view illustrating an integrated circuit device 4 according to some embodiments, and FIG. 12 is an enlarged view illustrating a portion A of FIG. 11. In FIGS. 11 and 12, the same reference numerals as in FIGS. 1 to 10 denote the same elements.

Referring to FIG. 11, a through-via 130 may be disposed in each through-via region TVR, and a prohibition region PHR may surround a plurality of through-via regions TVR or a plurality of through-vias 130 in a plan view. In some embodiments, a boundary PHR_B of the prohibition region PHR may be apart from a closest (e.g., an outermost) through-via region TVR (e.g., through-via 130) by a first distance d1, and the first distance d1 may range from about 1 micrometer to about 10 micrometers. However, embodiments are not limited thereto.

At least one power gating cell 150 may be disposed in the prohibition region PHR. For example, at least one power gating cell 150 may be disposed between a closest (e.g., an outermost) through-via region TVR and a nearest first logic block 120_c, and at least one other power gating cell 150 may be disposed between two adjacent through-via regions TVR. The power gating cell 150 between the closest through-via region TVR and the nearest first logic block 120_c may be spaced apart from the closest through-via region TVR by a second distance d2. The second distance d2 may be shorter than the first distance d1.

In some embodiments, although not shown in the accompanying drawings, power interconnection structures such as the first and second power interconnection structures 160p and 260p described with reference to FIGS. 9 and 10 may be further arranged in the prohibition region PHR.

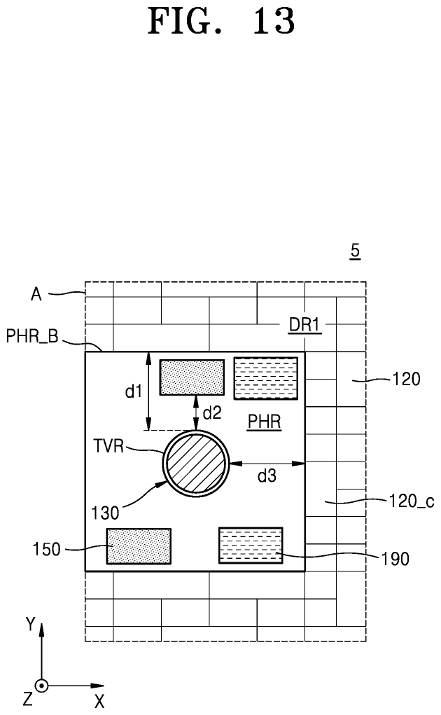

FIG. 13 is a plan view illustrating an integrated circuit device 5 according to some embodiments. In FIG. 13, the same reference numerals as in FIGS. 1 to 12 denote the same elements.

Referring to FIG. 13, at least one power gating cell 150 and at least one functional block 190 may be arranged in a prohibition region PHR. The power gating cell 150 may include a PMOS transistor and/or an NMOS transistor and may be configured to convert a power supply voltage provided from an external connection terminal 180 (refer to FIG. 4) into a virtual voltage and provide the virtual voltage to a plurality of first logic blocks 120 and/or the at least one function block 190. The at least one functional block 190 may be implemented with, for example, an inverter, a NAND gate, an AND gate, a NOR gate, an OR gate, an XOR gate, an XNOR gate, a multiplexer, an adder, a latch, a flip-flop, and/or the like. The at least one functional block 190 may include a circuit capable of performing various functions. In some embodiments, the at least one functional block 190 may have the planar FET structure, the finFET structure, and/or the multi-bridge channel FET which are described with reference to FIGS. 6 to 8. In some embodiments, the at least one functional block 190 may operate less sensitively to thermal stress and/or mechanical stress occurring during a process of forming a through-via 130 than the plurality of first logic blocks 120.

According to some embodiments, at least one power gating cell 150 and at least one functional block 190 may be disposed in the prohibition region PHR. Thus, the degree of integration of the integrated circuit device 5 may improve, and even when the density of through-vias 130 increases, area overhead caused by an increase in the area of prohibition regions PHR along with the increase of the density of through-vias 130 may reduce, thereby improving the efficiency of space utilization.

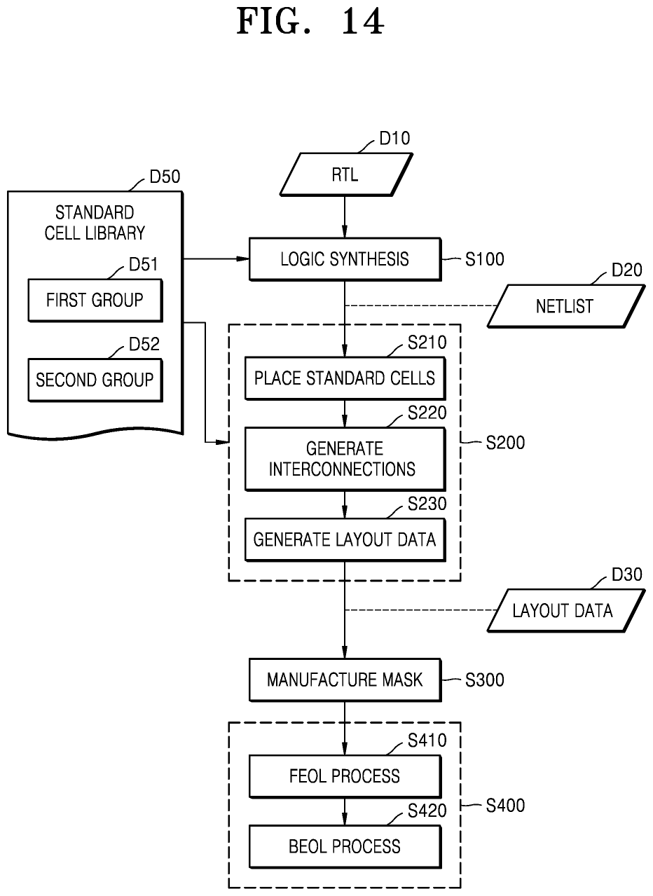

FIG. 14 is a flowchart illustrating a method of fabricating an integrated circuit including a plurality of standard cells, according to some embodiments.

A standard cell library D50 may include information about a plurality of standard cells, such as function information, characteristic information, and layout information, and may include first group information D51 and second group information D52. The first group information D51 may include information about standard cells arranged in a normal cell, and the second group information D52 may include information about standard cells arranged in a power gating cell.

Referring to FIG. 14, in operation S100, a logic synthesis operation may be performed to generate netlist data D20 from register transfer level (RTL) data D10. For example, a semiconductor design tool (for example, a logic synthesis tool) may generate a bitstream or the netlist data D20 including a netlist by performing a logic synthesis operation by referring to the standard cell library D50 from the RTL data D10 prepared using a hardware description language (HDL) such as a very high-speed integrated circuits program (VHSIC) hardware description language (VHDL) or Verilog.

In operation S200, a place & routing (P&R) operation may be performed to generate layout data D30 from the netlist data D20. As shown in FIG. 14, the P&R operation S200 may include a plurality of operations S210, S220, and S230.

In operation S210, standard cells may be placed. For example, a semiconductor design tool (for example, a P&R tool) may place a plurality of standard cells by referring to the standard cell library D50 from the netlist data D20. The semiconductor design tool may place standard cells on a grid having a present crossing length. First, power gating cells may be distributed at regular intervals, and then standard cells included in a normal cell may be placed.

In operation S220, interconnections may be generated. The interconnections may electrically connect output pins and input pins of the standard cells to each other, and may each include, for example, at least one via and at least one conductive pattern. The standard cells may be routed to the power gating cells by generating the interconnections.

In operation S230, layout data D30 may be generated. The layout data D30 may have a format such as graphic design system II (GDSII), and may include geometric information about the standard cells and the interconnections.

In operation S300, a mask may be manufactured. For example, patterns may be defined on a plurality of layers according to the layout data D30, and at least one mask (or photomask) for forming patterns on each of the plurality of layers may be manufactured.

In operation S400, an integrated circuit may be fabricated. For example, an integrated circuit may be fabricated by patterning a plurality of layers by using the at least one mask manufactured in operation S300. As shown in FIG. 14, operation S400 may include operations S410 and S420.

In operation S410, a front-end-of-line (FEOL) process may be performed. The FEOL process may refer to a process of forming individual devices, such as transistors, capacitors, resistors, or the like, on a substrate during an integrated circuit fabrication process. For example, the FEOL process may include planarizing and cleaning a wafer, forming a trench, forming a well, forming a gate line, forming a source and a drain, or the like.

In operation S420, a back-end-of-line (BEOL) process may be performed. The BEOL process may refer to a process of interconnecting individual devices, such as transistors, capacitors, resistors, or the like, during an integrated circuit fabrication process. For example, the BEOL process may include silicidizing gate, source, and drain regions, adding a dielectric, planarizing, forming a hole, adding a metal layer, forming a via, forming a passivation layer, or the like. The integrated circuit may then be packaged in a semiconductor package and used as a component in a variety of applications.

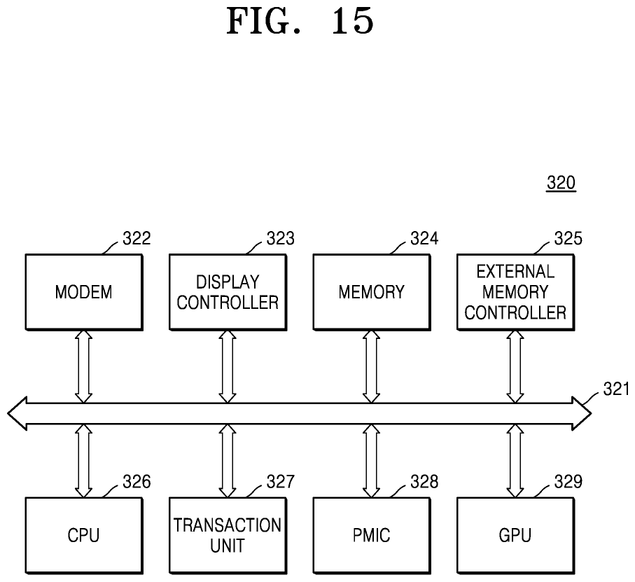

FIG. 15 is a block diagram including a system-on-chip (SoC) 320 according to some embodiments. The SoC 320, which is a semiconductor device, may include an integrated circuit according to an embodiment. The SoC 320 may refer to a single chip on which complex functional blocks such as intellectual property (IP) blocks configured to perform various functions may be provided, and a standard cell and a power rail may be included in each of the functional blocks of the SoC 320 according to embodiments. Thus, the degree of integration of the SoC 320 and the routing freedom of the SoC 320 may be improved.

Referring to FIG. 15, the SoC 320 may include a modem 322, a display controller 323, a memory 324, an external memory controller 325, a CPU 326, a transaction unit 327, a PMIC 328, and a GPU 329, and the function blocks of the SoC 320 may communicate with each other through a system bus 321. The embodiments of the SoC 320 are not limited to the above noted embodiments.

The CPU 326 capable of controlling all operations of the SoC 320 may control operations of the other functional blocks (322 to 325 and 327 to 329). The modem 322 may demodulate signals received from the outside circuit (system) of the SoC 320, or may modulate signals generated in the SoC 320 and transmit the signals to the outside circuit (system) of the SoC 320. Under control by the external memory controller 325, data may be transmitted to and received from an external memory device connected to the SoC 320. For example, a program and/or data stored in the external memory device may be provided to the CPU 326 or the GPU 329 under control by the external memory controller 325. The GPU 329 may execute program instructions related to graphics processing. The GPU 329 may receive graphic data through the external memory controller 325, and may transmit graphic data processed by the GPU 329 to the outside circuit (system) of the SoC 320 through the external memory controller 325. The transaction unit 327 may monitor data transaction in each of the function blocks, and the PMIC 328 may control power supplied to each of the function blocks under control by the transaction unit 327. The display controller 323 may control a display (or a display device) outside circuit (system) of the SoC 320 and may transmit data generated in the SoC 320 to the display. The embodiments of the SoC 320 are not limited thereto.

The memory 324 may include a nonvolatile memory such as electrically erasable programmable read-only memory (EEPROM), flash memory, phase change random access memory (PRAM), resistive random access memory (RRAM), nano-floating gate memory (NFGM), polymer random access memory (PoRAM), magnetic random access memory (MRAM), or ferroelectric random access memory (FRAM). The memory 324 may include a volatile memory such as dynamic random access memory (DRAM), static random access memory (SRAM), mobile DRAM, double data rate synchronous dynamic random access memory (DDR SDRAM), low power DDR (LPDDR) SDRAM, graphic DDR (GDDR) SDRAM, or a rambus DRAM (RDRAM). The embodiments of the memory 324 are not limited thereto.

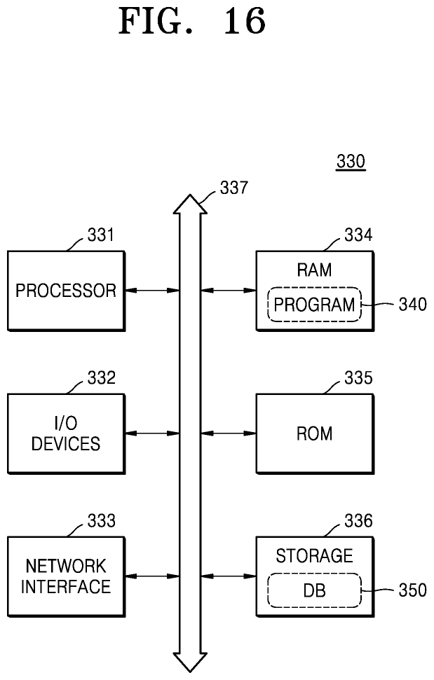

FIG. 16 is a block diagram illustrating a computing system 330 including a memory storing a program according to embodiments. According to an embodiment, at least some of operations included in a method of fabricating an integrated circuit (for example, the method shown in FIG. 14) may be performed by the computing system 330.

The computing system 330 may be a fixed computing system such as a desktop computer, a workstation, or a server, or may be a portable computing system such as a laptop computer. As shown in FIG. 16, the computing system 330 may include a processor 331, input/output devices 332, a network interface 333, random access memory (RAM) 334, read only memory (ROM) 335, and a storage 336. The processor 331, the input/output devices 332, the network interface 333, the RAM 334, the ROM 335, and the storage 336 may be connected to a bus 337 and communicate with each other through the bus 337.

The processor 331 may be referred to as a processing unit, and may include, for example, at least one core such as a micro-processor, an application processor (AP), a digital signal processor (DSP), or a GPU, which is capable of executing an arbitrary set of instructions (for example, Intel Architecture-32 (IA-32), 64-bit extension IA-32, x86-64, PowerPC, Sparc, MIPS, ARM, IA-64, or the like). For example, the processor 331 may access a memory, that is, the RAM 334 and/or the ROM 335 through the bus 337, and may execute instructions stored in the RAM 334 and/or the ROM 335.

The RAM 334 may store a program 340 or at least a portion thereof for manufacturing an integrated circuit according to an embodiment, and the program 340 may cause the processor 331 to perform at least some of operations included in a method of fabricating an integrated circuit. That is, the program 340 may include a plurality of instructions executable by the processor 331, and the plurality of instructions included in the program 340 may cause the processor 331 to perform, for example, the logic synthesis operation S100 and/or the P&R operation S200 which are described with reference to FIG. 14.

The storage 336 may not lose data stored therein even when the computing system 330 is powered off. For example, the storage 336 may include a nonvolatile memory device or a storage medium such as a magnetic tape, an optical disk, and/or a magnetic disk. In addition, the storage 336 may be detachable from the computing system 330. The storage 336 may store the program 340 according to an embodiment, and the program 340 or at least a portion of the program 340 may be loaded into the RAM 334 from the storage 336 before the program 340 is executed by the processor 331. Alternatively, the storage 336 may store a file written in a program language, and the program 340 or at least a portion of the program 340 generated from the file by a compiler or the like may be loaded into the RAM 334. In addition, as shown in FIG. 16, the storage 336 may store a database 350, and the database 350 may include information necessary for designing an integrated circuit.

The storage 336 may store data to be processed by the processor 331 or data processed by the processor 331. That is, the processor 331 may generate data by processing data stored in the storage 336 according to the program 340, and may store the generated data in the storage 336. For example, the storage 336 may store the RTL data D10, the netlist data D20, and/or the layout data D30 in FIG. 14.

The input/output devices 332 may include an input device such as a keyboard or a pointing device, and an output device such as a display device or a printer. For example, a user may use the input/output devices 332 to trigger the execution of the program 340 by the processor 331, input the RTL data D10 and/or the netlist data D20 described with reference to FIG. 14, or check the layout data D30 described with reference to FIG. 14.

The network interface 333 may provide access to a network provided outside circuit (system) of the computing system 330. For example, the network may include a plurality of computing systems and a plurality of communication links, and the communication links may include wired links, optical links, wireless links, and/or any other type of links.

While the inventive concept has been particularly shown and described with reference to embodiments thereof, it will be understood that various changes in form and details may be made therein without departing from the spirit and scope of the following claims. It should also be noted that in some alternate implementations, the steps of the method of manufacturing or the steps of operations herein may occur out of the order. For example, two steps described in succession may in fact be executed substantially concurrently or the steps may sometimes be executed in the reverse order. Moreover, the steps of method or operation may be separated into multiple steps and/or may be at least partially integrated. Finally, other steps may be added/inserted between the steps that are illustrated, and/or the steps may be omitted without departing from the scope of the present invention.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. In addition, “electrical connection” conceptually includes a physical connection and a physical disconnection. As used herein, the term “and/or” includes any and all combinations of one or more of the associated listed items. Moreover, the symbol “/” will be understood to be equivalent to the term “and/or.”

It will be understood that when an element is “on” a surface, the surface may face the element.

It will be understood that although the terms “first,” “second,” etc. may be used herein to describe various elements, these elements should not be limited by these terms. These terms are only used to distinguish one element from another. Thus, a first element could be termed a second element without departing from the teachings of the present embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is turned over, elements described as “below” or “beneath” other elements or features would then be oriented “above” the other elements or features. Thus, the term “below” can encompass both an orientation of above and below. The device may be otherwise oriented (e.g., rotated 90 degrees or at other orientations) and the spatially relative descriptors used herein may be interpreted accordingly.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope is to be determined by the broadest permissible interpretation of the following claims and their equivalents, and shall not be restricted or limited by the foregoing detailed description.

What is claimed is:

1. An integrated circuit device comprising:
a first chip; and
a second chip on the first chip;
wherein the first chip comprises:
a first substrate comprising a through-via region, a prohibition region, and a device region, the prohibition region surrounding the through-via region in a plan view;
a through-via in the through-via region and in the first substrate; and
a power gating cell in the prohibition region,
wherein the second chip comprises:
a second substrate; and
a second logic block on the second substrate, wherein the second logic block is configured to receive power and/or signals through the through-via.

2. The integrated circuit device of claim 1, wherein the first chip further comprises an external connection terminal on a lower surface of the first chip, and
the second logic block is configured to receive power and/or signals from the external connection terminal of the first chip through the through-via.

3. The integrated circuit device of claim 1, wherein the first substrate has a first surface of the first substrate and a second surface of the first substrate that is opposite to the first surface of the first substrate,
the power gating cell is on the first surface of the first substrate,
the second substrate has a first surface of the second substrate facing the second surface of the first substrate and a second surface of the second substrate opposite to the first surface of the second substrate, and
the second logic block is on the first surface of the second substrate.

4. The integrated circuit device of claim 1, wherein an interface between the prohibition region and the device region is at a first distance from the through-via region, and
the first distance ranges from about 1 micrometer to about 10 micrometers.

5. The integrated circuit device of claim 4, wherein the power gating cell is at a second distance from the through-via region, and
the second distance is shorter than the first distance.

6. The integrated circuit device of claim 5, wherein the first chip further comprises a plurality of first logic blocks in the device region,
wherein, the plurality of first logic blocks includes a nearest first logic block that is closest to the through-via region among the plurality of first logic blocks,
wherein the nearest first logic block is at a third distance from the through-via region, and
wherein the third distance is longer than the second distance.

7. The integrated circuit device of claim 1, wherein the first chip further comprises a power interconnection structure in the prohibition region, and
the power interconnection structure is electrically connected to the power gating cell.

8. The integrated circuit device of claim 1, wherein the first chip further comprises:
a power interconnection structure in the prohibition region; and
an external connection terminal on a lower surface of the first chip,
wherein the through-via is configured to receive power and/or signals from the external connection terminal through the power interconnection structure.

9. The integrated circuit device of claim 8, wherein the first substrate has a first surface of the first substrate and a second surface of the first substrate that is opposite to the first surface of the first substrate, and
the power interconnection structure comprises:
a first wiring layer at a first vertical distance from the first surface of the first substrate;
a second wiring layer at a second vertical distance from the first surface of the first substrate, wherein the second vertical distance is longer than the first vertical distance; and
a conductive via between the first wiring layer and the second wiring layer.

10. An integrated circuit device comprising:
a first semiconductor die comprising a plurality of first logic blocks and a through-via; and
a second semiconductor die on the first semiconductor die and comprising a second logic block,
wherein the first semiconductor die further comprises:
a first substrate comprising a through-via region, a prohibition region, and a device region, and having a first surface of the first substrate and a second surface of the first substrate that is opposite to the first surface of the first substrate;
a power gating cell in the prohibition region on the first surface of the first substrate; and
the plurality of first logic blocks in the device region on the first surface of the first substrate,
wherein the through-via in the through-via region and in the first substrate,
wherein the second semiconductor die further comprises:
a second substrate comprising a first surface of the second substrate facing the second surface of the first substrate and a second surface of the second substrate opposite to the first surface of the second substrate,
wherein the second logic block is on the first surface of the second substrate and electrically connected to the first semiconductor die through the through-via, and
wherein a first distance to the through-via region from a nearest first logic block among the plurality of first logic blocks closest to the through-via region is longer than a second distance to the through-via region from the power gating cell.

11. The integrated circuit device of claim 10, wherein, in a plan view, the prohibition region surrounds the through-via region, and
an interface between the prohibition region and the device region is at a distance of about 1 micrometer to about 10 micrometers from the through-via region.

12. The integrated circuit device of claim 10, wherein the first semiconductor die further comprises an external connection terminal on the first surface of the first substrate, and
the second logic block is configured to receive power and/or signals from the external connection terminal through the through-via.

13. The integrated circuit device of claim 10, wherein the first semiconductor die further comprises a power interconnection structure in the prohibition region, and
the power interconnection structure is electrically connected to the power gating cell.

14. The integrated circuit device of claim 10, wherein the first semiconductor die further comprises:
a power interconnection structure in the prohibition region; and
an external connection terminal on the first surface of the first substrate,
wherein the through-via is configured to receive power and/or signals from the external connection terminal through the power interconnection structure.

15. The integrated circuit device of claim 14, wherein the power interconnection structure comprises:
a first wiring layer at a first vertical distance from the first surface of the first substrate;
a second wiring layer at a second vertical distance from the first surface of the first substrate, wherein the second vertical distance is longer than the first vertical distance; and
a conductive via between the first wiring layer and the second wiring layer.

16. An integrated circuit device comprising:
a first semiconductor die; and
a second semiconductor die on the first semiconductor die;
wherein the first semiconductor die comprises:
a first substrate comprising a through-via region, a prohibition region, and a device region, the prohibition region surrounding the through-via region in a plan view, and the first substrate having a first surface of the first substrate and a second surface of the first substrate opposite to the first surface of the first substrate;
a through-via in the through-via region and in the first substrate;
a power gating cell in the prohibition region on the first surface of the first substrate; and
a first logic block in the device region on the first surface of the first substrate,
wherein the second semiconductor die comprises:
a second substrate having a first surface of the second substrate facing the second surface of the first substrate and a second surface of the second substrate opposite the first surface of the second substrate; and
a second logic block on the first surface of the second substrate and configured to receive power and/or signals through the through-via.

17. The integrated circuit device of claim 16, wherein the first semiconductor die further comprises a power interconnection structure in the prohibition region, and
the power interconnection structure is electrically connected to the power gating cell.

18. The integrated circuit device of claim 16, wherein the first semiconductor die further comprises:
a power interconnection structure in the prohibition region on the first surface of the first substrate; and
an external connection terminal on the first surface of the first substrate;
wherein the through-via is configured to receive power and/or signals from the external connection terminal through the power interconnection structure.

19. The integrated circuit device of claim 18, wherein the power interconnection structure comprises:
a first wiring layer at a first vertical distance from the first surface of the first substrate;
a second wiring layer at a second vertical distance from the first surface of the first substrate, wherein the second vertical distance is longer than the first vertical distance; and
a conductive via between the first wiring layer and the second wiring layer.

20. The integrated circuit device of claim 16, wherein an interface between the prohibition region and the device region is at a first distance from the through-via region, and
the first distance ranges from about 1 micrometer to about 10 micrometers.
